(19) United States
(12) Patent Application Publication
(10) Pub. No.: US 2026/0179605 A1
(43) Pub. Date: Jun. 25, 2026

(54) AUDIO DATA PROCESSING

(71) Applicant: Beijing Zitiao Network Technology Co., Ltd., Beijing (CN)

(72) Inventors: Hengyu LAI, Beijing (CN); Shuai LIU, Beijing (CN); Hui AI, Beijing (CN)

(21) Appl. No.: 19/346,508

(22) Filed: Sep. 30, 2025

(30) Foreign Application Priority Data
Dec. 24, 2024 (CN) 202411922389.5

(51) Int. Cl. G10L 15/04; G10L 15/22; G10L 15/30

(52) U.S. Cl. CPC G10L 15/04; G10L 15/22; G10L 15/30

(57) ABSTRACT

Embodiments of the disclosure relate to audio data processing. A method provided herein includes: determining a plurality of audio segments from first audio data by performing voice activity detection on the first audio data, each audio segment being determined to include a voice; dividing the plurality of audio segments into at least a first audio segment set and a second audio segment set based on at least a voiceprint similarity between adjacent audio segments of the plurality of audio segments; and determining a response delay between the first object and the second object based on timing information of the first audio segment set in the first audio data and timing information of the second audio segment set in the first audio data.

### CROSS-REFERENCE

The present application claims priority to Chinese Patent Application No. 202411922389.5, filed on December 24, 2024, and entitled "METHOD, APPARATUS, DEVICE, AND STORAGE MEDIUM FOR AUDIO DATA PROCESSING", the entire content of which is incorporated herein by reference.

### FIELD

Example embodiments of the present disclosure generally relate to the field of computer technology, and more particularly, to audio data processing.

### BACKGROUND

A question answering system is an automated system that utilizes natural language processing and machine learning techniques to simulate human answers. The question answering system can, based on the natural language question posed by the user, search relevant information from massive data, so as to provide an answer to the question posed by the user. In some application scenarios, the question answering system may further support a voice-based question answering manner, that is, both the question and the answer can be provided in the form of voice.

### SUMMARY

In a first aspect of the present disclosure, a method for audio data processing is provided. The method includes: determining a plurality of audio segments from first audio data by performing voice activity detection on the first audio data, each audio segment being determined to include a voice; dividing the plurality of audio segments into at least a first audio segment set and a second audio segment set based on at least a voiceprint similarity between adjacent audio segments of the plurality of audio segments, where the first audio segment set corresponds to a first object and the second audio segment set corresponds to a second object, and each audio segment set includes at least one audio segment of the plurality of audio segments; and determining a response delay between the first object and the second object based on timing information of the first audio segment set in the first audio data and timing information of the second audio segment set in the first audio data.

In a second aspect of the present disclosure, an apparatus for audio data processing is provided. The apparatus includes: an audio segment determination module configured to determine a plurality of audio segments from first audio data by performing voice activity detection on the first audio data, each audio segment being determined to include a voice; an audio segment division module configured to divide the plurality of audio segments into at least a first audio segment set and a second audio segment set based on at least a voiceprint similarity between adjacent audio segments of the plurality of audio segments, where the first audio segment set corresponds to a first object and the second audio segment set corresponds to a second object, and each audio segment set includes at least one audio segment of the plurality of audio segments; and a response delay determination module configured to determine a response delay between the first object and the second object based on timing information of the first audio segment set in the first audio data and timing information of the second audio segment set in the first audio data.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that the summary described in this disclosure is not intended to limit key features or important features of embodiments in the present disclosure, nor is it intended to limit the scope in the present disclosure. Other features in the present disclosure will become readily understood from the following description.

### BRIEF DESCRIPTION OF DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 illustrates a schematic diagram of an example environment according to some embodiments of the present disclosure;

FIG. 2 illustrates a flowchart of an example process of a method for audio data processing according to some embodiments of the present disclosure;

FIG. 3 illustrates a schematic diagram of an example of time domain acoustic features of a plurality of given frames according to some embodiments of the present disclosure;

FIG. 4 illustrates a schematic diagram of an example of frequency domain acoustic features of a plurality of given frames according to some embodiments of the present disclosure;

FIG. 5 illustrates a schematic diagram of an example of a response delay according to some embodiments of the present disclosure;

FIG. 6A illustrates a flowchart of a process for dividing an audio segment into audio segment sets corresponding to different objects according to some embodiments of the present disclosure;

FIG. 6B illustrates a schematic diagram of an example of a time gap of a plurality of audio segments according to some embodiments of the present disclosure;

FIG. 7 illustrates a schematic structural block diagram of an apparatus for audio data processing according to some embodiments of the present disclosure; and

FIG. 8 illustrates a block diagram of an electronic device in which one or more embodiments of the present disclosure may be implemented.

### DETAILED DESCRIPTION

Embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

It should be noted that the title of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or same objects. Other explicit and implicit definitions may also be included below.

The embodiments in the present disclosure may relate to user data, acquisition and/or use of data, and the like. These aspects shall comply with the requirements of corresponding laws, regulations and relevant provisions. In the embodiments in the present disclosure, the collection, acquisition, processing, manufacturing, forwarding, use of all data and the like are carried out with user's knowledge and consent. Accordingly, in the implementation of the embodiments in the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly described above, the question answering system can, based on natural language questions posed by the user, search relevant information from massive data, so as to provide answers to questions posed by the user. In a voice-based question answering scenario, a response delay is usually concerned. The response delay can indicate a time gap from the end of a question of a questioner to the start of an answer of an answerer. The response time delay of the question answering system can reflect the processing speed of the question answering system for the question.

At present, the determination of the response delay mainly includes two stages of recording and result labeling. The recording stage is responsible for capturing actual conversation data between the user and the question answering system, and the result labeling stage performs a detailed analysis on the data to determine a specific delay of each question-answer pair. However, in this process, the labeling stage faces various challenges.

In a traditional labeling method, firstly, the recorded audio and video data needs to be imported into a professional processing tool. Then, an annotator needs to observe a voice waveform, and determine the start point and the end point of each question-answer pair through manual recognition, so as to calculate the specific delay of each question-answer pair. This method highly depends on manual operations, which is not only time-consuming and laborious, but also greatly affected by subjective judgment of individuals.

In view of this, the embodiments of the present disclosure provide a solution for audio data processing. According to this solution, firstly, a plurality of audio segments from first audio data is determined by performing voice activity detection on the first audio data, each audio segment being determined to include a voice. Then, the plurality of audio segments is divided into at least a first audio segment set and a second audio segment set based on at least a voiceprint similarity between adjacent audio segments of the plurality of audio segments. The first audio segment set corresponds to a first object and the second audio segment set corresponds to a second object, and each audio segment set includes at least one audio segment of the plurality of audio segments. Further, a response delay between the first object and the second object is determined based on timing information of the first audio segment set in the first audio data and timing information of the second audio segment set in the first audio data.

It will be more clearly understood from the following description that the solution of the present disclosure accurately identifies and extracts a plurality of audio segments including valid voice from the first audio data by the voice activity detection technology. According to the solution of the present disclosure, and adjacent audio segments are divided into sets belonging to different objects by using the voiceprint similarity, for example, the first audio segment set belonging to the first object and the second audio segment set belonging to the second object, thereby realizing an effective distinction of voices of different objects. In turn, the solution of the present disclosure calculates a response delay between the first object and the second object based on the audio segment sets and the timing information of the audio segment sets in the first audio data. The series of operations implement automatic processing of delay evaluation, thereby improving accuracy and efficiency of delay evaluation.

The solution of the present disclosure not only reduces cost and time consumption of manual labeling, but also ensures consistency and reliability of evaluation results in an objective and automated manner. In addition, in a scenario where a conversation involves a question answering system, the solution of the present disclosure can accurately and effectively evaluate a response delay of the question answering system, thereby providing effective support for optimizing application performance and improving user experience.

Various example implementations of this solution will be described in detail below in conjunction with the accompanying drawings.

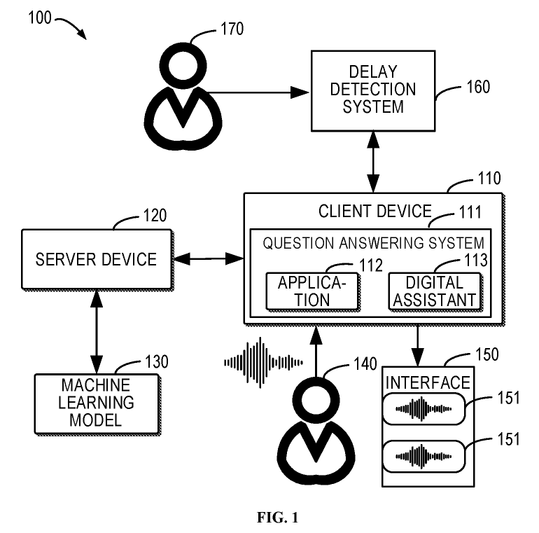

FIG. 1 illustrates a schematic diagram of an example environment 100 according to some embodiments of the present disclosure. In the example environment 100, a question answering system 111 is installed in a client device 110. The question answering system 111 may deal with questions posed by a user 140 and provide corresponding answers. The questions and answers may be provided in the form of voice.

In the example environment 100, a user 170 may detect a response time delay of the question answering system 111 through a delay detection system 160, that is, detect a response speed of the question answering system 111 in the whole process from receiving the question of the user 140 to providing the answer.

It should be noted that, in the example environment 100, the question answering system 111 is illustrated as being formed by an application 112 and a digital assistant 113. However, in the embodiments of the present disclosure, the structure of the question answering system 111 is not limited thereto. For example, the question answering system 111 may also be formed solely by the digital assistant 113 and/or solely by the application 112, as long as the question answering system 111 has a voice-based automatic question answering function.

In the example environment 100, the user 140 may interact with the application 112 via the client device 110 and/or an attachment device of the client device 110. In some implementations, the application 112 may be authorized to acquire voice via an audio acquisition device (e.g., a microphone) of the client device 110 and acquire images via an image acquisition device (e.g., a camera) of the client device 110, and the like.

In some embodiments, the application 112 and the digital assistant 113 may be downloaded and installed on the client device 110. In some embodiments, the application 112 and the digital assistant 113 may also be accessed in other manners, such as through web page access and the like.

In the embodiments of the present disclosure, the application 112 may be any suitable application having a response function, which may include, but is not limited to, one or more of the following: a chat application component (also referred to as an instant messaging application component), a browser application component, a planning application component, a document application component, an audio and video conference application component, a mail application component, a task application component, a calendar application component, an objective and key results (OKR) application component, and the like. It would be appreciated that although a single application is shown in FIG. 1, in practice, a plurality of applications may be installed on the client device 110. In some embodiments, the application 112 may include a multifunctional collaboration platform, for example, an office collaboration platform (also referred to as an office suite), which may provide integration of multiple types of service components to facilitate office, communication, and other activities. In the multifunctional collaboration platform, the user may start different service components as needed to complete corresponding information processing, sharing, communication and the like.

In some embodiments, the digital assistant 113 may be provided by a separate application, or may be integrated in a certain application 112 capable of providing a content entity. An application service component for providing a client interface of the digital assistant may correspond to a single function application service component or a multifunction collaboration platform, such as an office suite or other collaboration platform capable of integrating multiple components. It would be appreciated that that similar to the application, although a single digital assistant is shown in FIG. 1, in practice, a plurality of digital assistants may be provided.

The digital assistant 113 may act as an assistant of the user, with conversation and information processing capabilities. In embodiments of the present disclosure, the digital assistant 113 is used for interaction with the user 140 to assist the user 140 in using the client device 110 or the application 112. In some embodiments, a plurality of interaction modes between the user 140 and the digital assistant 113 may be provided, and flexible switching between the plurality of interaction modes may be performed. In a case that a certain interaction mode is triggered, a corresponding interaction area is presented to facilitate interaction between the user 140 and the digital assistant 113. In different interaction modes, the interaction manner between the user 140 and the digital assistant 113 is different, thereby flexibly adapting to interaction requirements in different application scenarios.

In the example environment 100, in response to the application 112 being started, the client device 110 may present an interface 150 of the application 112 and/or the digital assistant 113. The interface 150 may include, for example, an interaction interface of the application 112 and the digital assistant 113. In some embodiments, an interaction window between the user 140 and the digital assistant 113 may be presented in the interface 150. In the interaction window, the user 140 may have a conversation with the digital assistant 113 by inputting natural language, a picture, an audio file, a video file, a web page file, etc. , so as to indicate the digital assistant to assist in completing various tasks.

The interaction window between the digital assistant 113 and the user 140 may include a chat window, such as a chat window in an instant messaging application or in an instant messaging module of a particular application. In the chat window, the interaction between the digital assistant 113 and the user 140 may be presented in the form of a chat message 151. The user 140 may interact with the chat message 151 in a variety of ways. For example, when the user 140 wants to listen to message content, the user 140 may click the chat message 151 to initiate the voice playing function, thereby delivering the message to the user 140 in the form of voice. When the user 140 desires to view the message content in a more intuitive manner, the user 140 may choose to convert the chat message 151 into a textual form to present in the interactive window in a clear and readable format. Alternatively or additionally, the interaction window between the digital assistant 113 and the user 140 may further include other types of windows, such as a window in a floating window mode, where the user 140 may trigger the digital assistant 113 to perform a corresponding operation by inputting an instruction, selecting a shortcut instruction, and the like.

In some embodiments, the digital assistant 113 may support an interaction mode of a chat window, also referred to as a conversation mode. In this interaction mode, a chat window between the user 140 and the digital assistant 113 is presented, and in the chat window, the user 140 interacts with the digital assistant 113 through the chat message. In the conversation mode, the digital assistant 113 may perform a task according to the chat message in the chat window. In the interaction window, the user 140 inputs an interaction message, and the digital assistant 113 provides a reply message in response to the user input. By selecting the digital assistant 113, a chat window with the digital assistant 113 may be opened. The chat window may include interface elements for information interaction, such as an input box, a message list, a message bubble, and the like.

In some embodiments, a communication connection is established between the client device 110 and the server device 120. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the client device 110 and the server device 120 may implement signaling interaction through a communication connection between the client device 110 and the server device 120, so as to realize supply of services of the application 112 and/or the digital assistant 113.

As shown in FIG. 1, the server device 120 may invoke a machine learning model 130 to support a response function of the application 112 based on the output of the machine learning model 130. The machine learning model 130 may be based on any suitable model structure, including but not limited to, a Transformer model, a convolutional neural network (CNN), a recurrent neural network (RNN), a deep neural network (DNN), and the like. In some embodiments, the machine learning model 130 may be based on a language model (LM). The language model may have a question answering capability by learning from a large amount of corpora. The machine learning model 130 may also be based on other suitable models.

The machine learning model 130 may be deployed on the server device 120, or may be deployed on other devices. The machine learning model 130 may include one or more machine learning models. It should be noted that if the machine learning model 130 includes a plurality of machine learning models, the plurality of machine learning models may have different structures, purposes, and functions, and the present disclosure is not limited thereto. It should be noted that a machine learning model may also be deployed locally in the client device 110 (not shown in the figure), and the client device 110 may also directly invoke the local machine learning model to support the response function of the application 112 based on the output of the local machine learning model.

The client device 110 and/or the delay detection system 160 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices, or any combination thereof. In some embodiments, the client device 110 and/or the delay detection system 160 may also support any type of interface for the user (such as a “wearable” circuit, etc. ).

The server device 120 may be a standalone physical server, a server cluster or a distributed system composed of multiple physical servers, or may also be a cloud server that provides basic cloud computing services such as cloud services, cloud databases, cloud computing, cloud functions, cloud storage, network services, cloud communication, middleware services, domain name services, security services, content distribution networks, and big data and artificial intelligence platforms. The server device 120 may include, for example, a computing system/server, such as a mainframe, an edge computing node, a computing device in cloud environments, or the like.

It should be understood that the structures and functions of the various elements in the environment 100 are described for illustrative purposes only and do not imply any limitation to the scope of the present disclosure.

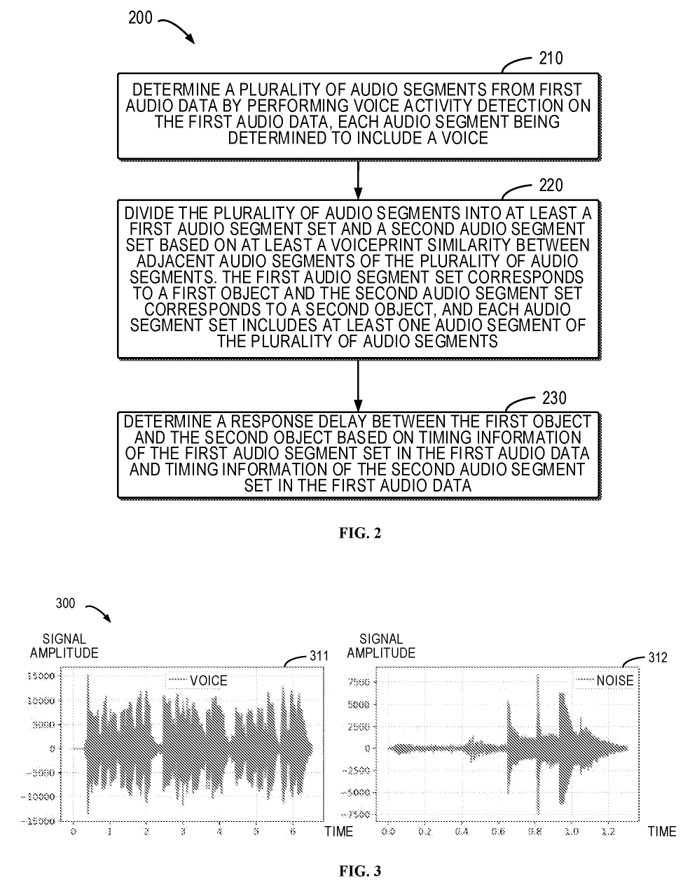

FIG. 2 illustrates a flowchart of an example process 200 of a method for audio data processing according to some embodiments of the present disclosure. The example process 200 may be implemented at the delay detection system 160 of FIG. 1. The example process 200 will be described below with reference to the example environment 100 of FIG. 1.

At block 210, the delay detection system 160 determines a plurality of audio segments from first audio data by performing voice activity detection (VAD) on the first audio data, each audio segment being determined to include a voice.

As an example, the first audio data may be pre-recorded audio data of a question-and-answer segment. The first audio data may be recorded by using any suitable device. Alternatively or in addition, these devices may implement the automation of recording by means of a predetermined command (e.g., python + command line). In some embodiments, if a delay test needs to be performed on the specific question answering system 111, the first audio data may further include test audio data obtained for the question answering system 111, and the test audio data may include dialogue voice between the question answering system 111 and the user 140.

The voice activity detection is a technology for voice processing, mainly for detecting whether a voice signal exists in audio. By means of the voice activity detection, the delay detection system 160 may separate audio segments including voices from the original first audio data, and may remove audio segments that do not include voices. In some embodiments, when performing the voice activity detection, the delay detection system 160 may analyze a time domain acoustic feature and/or a frequency domain acoustic feature of the first audio data, and further determine, based on the analysis result, a plurality of audio segments including voices.

In some embodiments, the delay detection system 160 may perform frame segmentation on the first audio data, that is, cut the continuous audio stream into a series of independent frames. For a given frame (e.g., each frame) in the first audio data, the delay detection system 160 determines whether the given frame is a valid frame including a voice based on a time domain acoustic feature and/or a frequency domain acoustic feature of the given frame. Then, the delay detection system 160 determines the plurality of audio segments by at least combining consecutive valid frames in the first audio data into an audio segment.

The time domain acoustic feature describes the acoustic properties of the given frame over the time domain. In some embodiments, the time domain acoustic feature includes a magnitude of acoustic energy. Alternatively or additionally, the time domain acoustic feature includes a duration of acoustic energy exceeding a threshold. As an example, the magnitude of the acoustic energy, i.e., the intensity or loudness of the audio signal of the given frame, may be represented in the time domain as the sum of the squares of amplitudes of a sound waveform.

FIG. 3 illustrates a schematic diagram of an example 300 of time domain acoustic features of a plurality of given frames according to some embodiments of the present disclosure. The left diagram in FIG. 3 schematically illustrates a schematic diagram of a signal amplitude 311 of a plurality of given frames including voices, and the right diagram in FIG. 3 schematically illustrates a schematic diagram of a signal amplitude 312 of a plurality of given frames including noise. In FIG. 3, a horizontal axis represents time, and a vertical axis represents signal amplitude (a larger signal amplitude indicates a greater acoustic energy). It can be clearly seen from FIG. 3 that the signal amplitude 311 and the signal amplitude 312 reflect the acoustic energy level of the given frame, which may serve as an important basis for distinguishing between voices and non-voices (such as silence and noise). In addition to the magnitude of acoustic energy, the embodiments of the present disclosure may further analyze the given frame in conjunction with the duration of acoustic energy exceeding the threshold. The duration of the acoustic energy exceeding the threshold is used to measure the length of a time period that the energy in the first audio data exceeds a certain level, which helps to further distinguish different types of sound events. For example, a short noise (such as a door opening sound, a table and chair collision sound, etc. ) usually has a short duration and a small energy, and a voice signal usually lasts for a longer time and has a greater energy.

As an example, the delay detection system 160 may calculate the acoustic energy for the given frame. The delay detection system 160 compares the acoustic energy of the given frame with a threshold to determine whether the acoustic energy of the given frame exceeds the threshold. For the given frame with acoustic energy exceeding the threshold, the delay detection system 160 may further calculate a duration of acoustic energy exceeding the threshold. By comparing the duration of acoustic energy exceeding the threshold to a reference duration (e.g., a typical duration of short noise), the delay detection system 160 may preliminarily determine whether the given frame includes a voice or a short noise.

For given frames preliminarily determined to include a voice based on the time domain acoustic feature, the delay detection system 160 may preliminarily combine a plurality of consecutive given frames among the given frames into a frame set, so as to obtain a plurality of frame sets. Then, for each frame set, the delay detection system 160 may determine a frequency domain acoustic feature of each given frame in each frame set by performing a Fourier transform or the like. In turn, the delay detection system 160 may further determine whether the given frames are indeed valid frames including a voice based on the frequency domain acoustic feature of the given frame in each frame set.

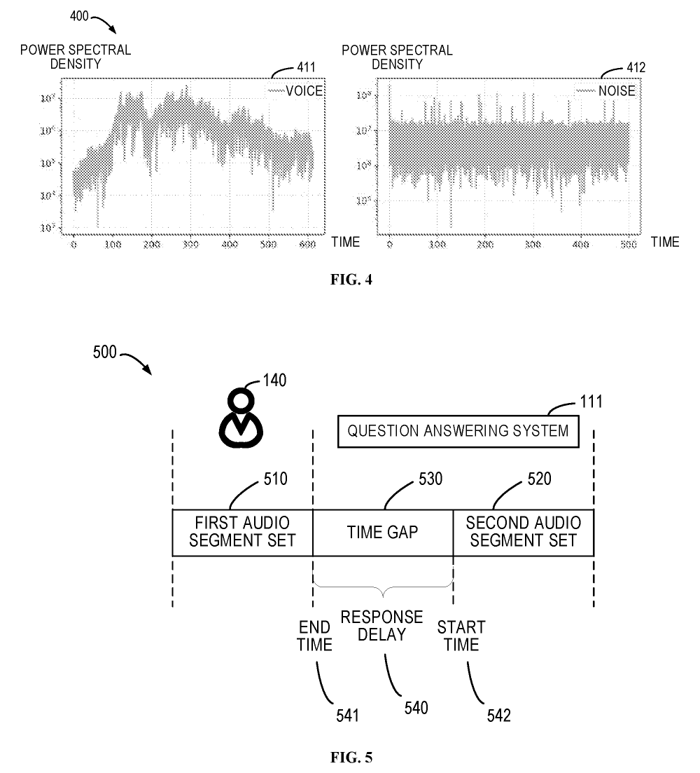

The frequency domain acoustic feature is used to describe acoustic properties of the given frame in the frequency domain. As an example, the frequency domain acoustic feature of the given frame may be represented in a manner such as power spectral density. FIG. 4 illustrates a schematic diagram of an example 400 of frequency domain acoustic features of a plurality of given frames according to some embodiments of the present disclosure. The left diagram in FIG. 4 schematically illustrates a schematic diagram of a power spectral density 411 of a plurality of given frames including voice, and the right diagram in FIG. 4 schematically illustrates a schematic diagram of a power spectral density 412 of a plurality of given frames including noise. It can be clearly seen from FIG. 4 that a voice, as a non-stationary signal, usually has relatively drastic frequency variations. Most noises (such as sounds of air conditioners, fans, etc. ) are stationary, with relatively stable frequency variations usually concentrated at a certain specific frequency or within a frequency range. To distinguish between voices and persistent noise, the delay detection system 160 may capture stable characteristics of the first audio data in the frequency domain by using the frequency domain acoustic feature. In some embodiments, the frequency domain acoustic features may include statistics such as a mean value of frequency, a variance of frequency, a flatness of the frequency spectrum, and a kurtosis of the frequency spectrum. For voice signals, these frequency domain acoustic features exhibit large fluctuations and variations due to their drastic frequency variation; while for the persistent noise, since their frequency is relatively stable, these frequency-domain acoustic features exhibit relatively steady and consistent trends.

As an example, based on the extracted frequency domain acoustic features, the delay detection system 160 may classify the frequency domain acoustic features by using, for example, a classifier (e.g., a support vector machine, a neural network, etc. ), or the like. The classifier may determine whether each given frame is a voice or a noise according to a preset threshold or a model obtained through training.

Once it is determined which frames are valid frames including a voice, the delay detection system 160 may enter a frame combination stage. In this stage, the delay detection system 160 may combine consecutive valid frames in the first audio data into an audio segment. By repeating this operation, the plurality of audio segments may be obtained, and each segment includes a voice. These audio segments represent actual voice content in the conversation, which may be a question of the user 140, or may be an answer of the question answering system 111 (or other users). By combining consecutive valid frames, the delay detection system 160 can preliminarily aggregate start and end points of dialogue sentences and can remove parts of the original first audio data irrelevant to voices, such as noise and/or ambient sound, thereby providing a basis for subsequent delay calculation.

Referring back to FIG. 2, at block 220, the delay detection system 160 divides the plurality of audio segments into at least a first audio segment set and a second audio segment set based on at least a voiceprint similarity between adjacent audio segments of the plurality of audio segments. The first audio segment set corresponds to a first object and the second audio segment set corresponds to a second object, and each audio segment set includes at least one audio segment of the plurality of audio segments.

It should be noted that in the text, the term “adjacent” or similar expression may refer to two or more objects that are immediately next to each other in time or space and have a common boundary or an adjacency relationship. For example, in this context, “two adjacent audio segments” may refer to two audio segments that are immediately next to each other in time and between which no other audio segment exists. The term “continuous” or similar expression may refer to two or more objects that are uninterrupted, continuously performed, or arranged temporally or spatially. For example, in this context, the term “continuous audio segments” may refer to two or more audio segments that are uninterrupted in time.

As an example, the first audio data may be pre-recorded audio data of a question-and-answer segment, and the first object may refer to a party that initiates a question or speaks first in the question-and-answer segment. The second object may refer to a party, in the question-and-answer segment, that responds to a question or a statement of the first object.

The voiceprint, as a unique sound feature of different sound sources (for example, different objects), high distinguishability and stability. In voice communication or voice analysis, different objects may be identified by using a voiceprint technology. Therefore, in the process of delay detection, by calculating the voiceprint similarity of the adjacent audio segments, the delay detection system 160 may infer whether the adjacent audio segments are from the same object (for example, the first object or the second object).

As an example, the delay detection system 160 may traverse all audio segments, and for each pair of adjacent audio segments, the delay detection system 160 may calculate a voiceprint similarity between them. As an example, the voiceprint similarity may be obtained by using a plurality of algorithms, such as cosine similarity, Euclidean distance, etc. , and which algorithm is specifically selected depends on actual requirements, and the embodiments of the present disclosure are not limited thereto.

After calculating the voiceprint similarity of all adjacent audio segments, the delay detection system 160 may obtain a voiceprint similarity threshold. When a voiceprint similarity between two adjacent audio segments is higher than the voiceprint similarity threshold, the delay detection system 160 regards the two adjacent audio segments as being from the same object and incorporates them into the same audio segment set; otherwise, the two adjacent audio segments are incorporated into different audio segment sets. In this way, by continuously incorporating adjacent audio segments belonging to the same object into the same audio segment set, the first audio segment set corresponding to the first object and the second audio segment set corresponding to the second object may be divided from a plurality of discrete audio segments.

It should be noted that, according to actual requirements, the delay detection system 160 may further divide more audio segment sets. For example, if the first audio data includes voiceprint features of more objects, the delay detection system 160 may divide the plurality of audio segments into audio segment sets corresponding to the objects in the foregoing manner.

At block 230, the delay detection system 160 determines a response delay between the first object and the second object based on timing information of the first audio segment set in the first audio data and timing information of the second audio segment set in the first audio data.

As an example, the first object may be any entity capable of initiating a conversation, such as a person, a machine, or a system. The first object initiates a conversation by posing a question. The second object may be any entity capable of responding to a conversation, such as a person, a machine, or a system. The response delay may refer to a time delay from when the second object receives the question of the first object to when the second object provides an answer. It reflects a speed of the response of the second object.

As an example, the first audio data originates from interactions between objects during a conversation. The conversation may be recorded in real time, or may be a conversation record that is recorded and stored in advance. The first audio data includes at least one complete conversation process between the first object and the second object.

It should be noted that the above roles of the first object and the second object in the conversation are merely illustrative, and this does not constitute a limitation on the embodiments of the present disclosure. For example, according to an actual situation, the second object may also be an initiator of the conversation, and the first object may be a responder of the conversation.

In some embodiments, the second object corresponds to the question answering system 111, and the first object provides a question voice to the question answering system 111. In such cases, the determined response delay indicates a response delay of the question answering system 111.

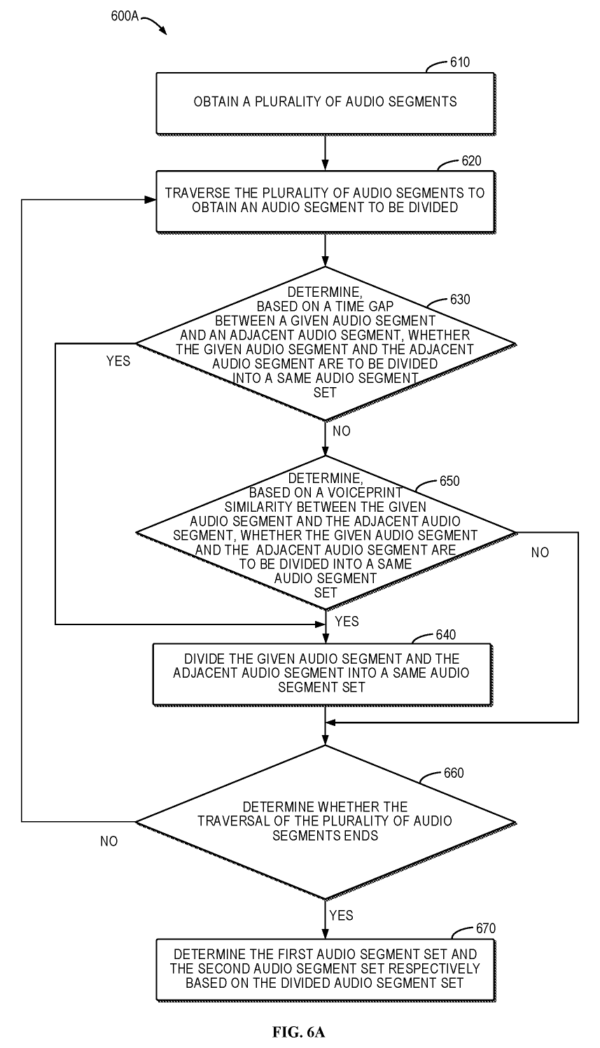

FIG. 5 illustrates a schematic diagram of an example 500 of the response delay according to some embodiments of the present disclosure. Referring to FIG. 5, the first object is illustrated as a user 140 initiating a conversation and the second object is illustrated as the question answer system 111. In this example, the response delay 540 may refer to a time delay indicating a period from when the question answering system 111 receives a question from the user 140 to when the question answering system 111 provides an answer. It reflects the speed of the question answering system 111 for processing the question, that is, a response speed of the question answering system 111 to the question posed by the user 140. Such a response delay may be served as an important indicator for measuring the performance of the question answering system 111, thereby indicating how to optimize the question answering system 111.

In practical applications, the question-and-answer process includes a plurality of complex scenarios, and in different scenarios, the process of determining a response delay 540 is different. Hereinafter, interactions between the user 140 and the question answering system 111 are taken as an example to illustrate manners of determining the response delay 540 in respective question and answer scenarios.

As an example, the question-and-answer process includes at least a one-question-and-one-answer scenario, that is, the user 140 presents a question, and the question answering system 111 provides a corresponding answer. In this scenario, the response delay 540 may be a time difference between the end time of the user 140 posing the question and the start time of the question answering system 111 providing an answer.

As an example, the question-and-answer process further includes a case where the user 140 pauses during the questioning process. In this scenario, the response delay 540 may be a time difference between a time point at which the user 140 completes all descriptions about the question and a start time at which the question answering system 111 provides the answer.

As an example, the question-and-answer process further includes a one-question-and-multiple-answers scenario, which usually occurs when the user 140 poses a question and the question answering system 111 successively provides multiple answers. In this scenario, the response delay 540 may be a time difference between the end time of the user 140 posing the question and the start time of the first answer provided by the question answering system 111.

As an example, the question-and-answer process further includes a multiple-questions-and-one-answer scenario. In contrast to the one-question-and-multiple-answers scenario, the multiple-questions-and-one-answer scenario refers to a case where the user 140 continuously poses a plurality of questions and the question answering system 111 provides a comprehensive answer. In this scenario, the response delay 540 may be a time difference between the end time of the last question posed by the user 140 and the start time of the answer provided by the question answering system 111.

As an example, the question-and-answer process further includes a multiple-questions-and-multiple-answers scenario. This typically occurs when the user 140 continuously poses a plurality of questions and the question answering system 111 successively provides a plurality of answers to the plurality of questions. In this scenario, the response delay 540 may be the time difference between the end time of the last question posed by the user 140 and the start time of the first answer provided by the question answering system 111.

In some embodiments, the delay detection system 160 may process a plurality of audio segments in the first audio data by using an iterative method, so as to accurately divide the audio segments into audio segment sets corresponding to different objects. This process may be performed based on a determination of a voiceprint similarity and/or a time gap 530 between the audio segments.

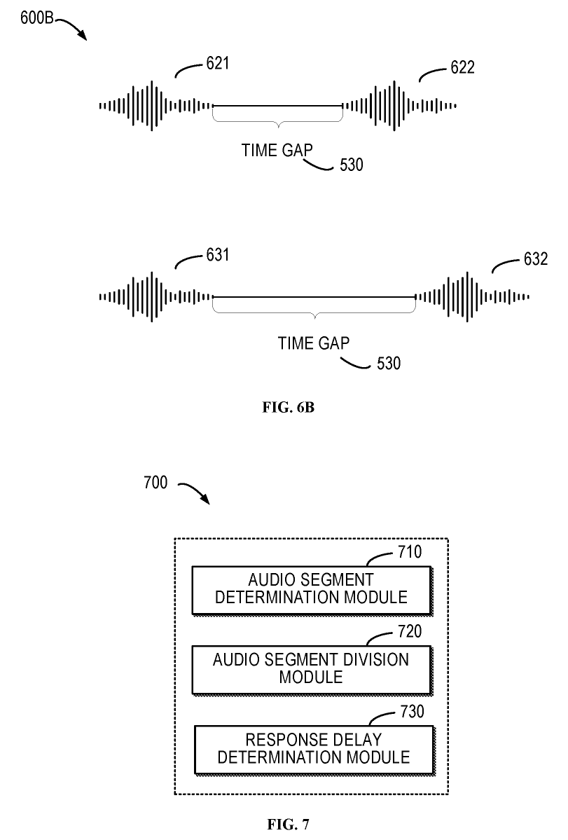

FIG. 6A illustrates a flowchart of a process 600A for dividing audio segments into audio segment sets corresponding to different objects according to some embodiments of the present disclosure.

Referring to FIG. 6A, at block 610, the delay detection system 160 obtains a plurality of audio segments. As an example, the plurality of audio segments herein may be obtained by combining consecutive valid frames based on time domain acoustic features and/or frequency domain acoustic features. The specific process may refer to the embodiments described above, thus will not be described herein again.

In some embodiments, the delay detection system 160 divides the plurality of audio segments into at least a first audio segment set 510 and a second audio segment set 520 based on a voiceprint similarity and a time gap 530 between adjacent audio segments.

As an example, the time gap 530 may refer to a time difference between an end time of a preceding audio segment and a start time of a subsequent audio segment among two adjacent audio segments. FIG. 6B illustrates a schematic diagram of an example 600B of the time gap 530 of a plurality of audio segments according to some embodiments of the present disclosure. The upper graph in FIG. 6B schematically illustrates two audio segments 601 and 602 having a shorter time gap 530 (e.g., shorter than a gap threshold of 1.5s), and the lower graph in FIG. 6 schematically illustrates two audio segments 603 and 604 having a longer time gap 530 (e.g., longer than the gap threshold of 1.5s). Referring to FIG. 6B, the longer time gap 530 means that a speaking object is switched during the question-and-answer process, while the shorter time gap 530 indicates that consecutive speeches are from the same object. If the time gap 530 between two adjacent audio segments indicates that the two audio segments are consecutive speeches of the same object, the delay detection system 160 may divide the two adjacent audio segments into a same audio segment set.

The voiceprint similarity may measure whether two audio segments (which may be adjacent or non-adjacent) are from the same object. The delay detection system 160 may determine the voiceprint similarity by using any voiceprint recognition algorithm. Such a voiceprint recognition algorithm may be implemented based on, for example, a deep neural network (DNN), a convolutional neural network (CNN), or a recurrent neural network (RNN). The delay detection system 160 may compare the voiceprint similarity of the two audio segments with a preset similarity threshold so as to determine how to process the two audio segments. If the voiceprint similarity of the two audio segments exceeds the similarity threshold, this means that they are likely from the same object. Therefore, the delay detection system 160 may divide the two audio segments into the same audio segment set.

In some embodiments, the delay detection system 160 performs the processes shown in blocks 620 to 660 iteratively on each audio segment of the plurality of audio segments, in a time sequence of the plurality of audio segments in the first audio data, so as to divide the plurality of audio segments into a first audio segment set 510 and a second audio segment set 520.

Referring back to FIG. 6A, at block 620, the delay detection system 160 traverses the plurality of audio segments to obtain an audio segment (e.g., a given audio segment) to be divided.

At block 630, the delay detection system 160 determines, based on the time gap 530 between a given audio segment and an adjacent audio segment, whether the given audio segment and the adjacent audio segment are to be divided into the same audio segment set. If the time gap 530 between the given audio segment and the adjacent audio segment is less than the gap threshold, at block 640,the delay detection system 160 divides the given audio segment and the adjacent audio segment into a same audio segment set. If the time gap 530 between the given audio segment and the adjacent audio segment exceeds the gap threshold, at block 650, the delay detection system 160 determines, based on a voiceprint similarity between the given audio segment and the adjacent audio segment, whether the given audio segment and the adjacent audio segment are to be divided into the same audio segment set.

If the voiceprint similarity between the given audio segment and the adjacent audio segment in the plurality of audio segments exceeds the similarity threshold, at block 640, the delay detection system 160 divides the given audio segment and the adjacent audio segment into the same audio segment set. If the voiceprint similarity between the given audio segment and the adjacent audio segment fails to exceed the similarity threshold, at block 660, the delay detection system 160 determines whether a traversal of the plurality of audio segments is completed, that is, whether there is still an audio segment to be divided in the plurality of audio segments. If there is still an audio segment to be divided in the plurality of audio segments, the process returns to block 620 to obtain a next audio segment to be divided, so as to perform an iteration on the next audio segment. If there is no audio segment to be divided in the plurality of audio segments, at block 670, the delay detection system 160 determines the first audio segment set 510 and the second audio segment set 520 respectively based on the divided audio segment sets.

For example, after the foregoing iteration, the delay detection system 160 divides two audio segment sets. In this case, the delay detection system 160 may, based on objects (that is, sound sources) corresponding to the two audio segment sets, determine one of the audio segment sets as the first audio segment set 510 corresponding to the first object, and determine the other audio segment set as the second audio segment set 520 corresponding to the second object.

In the foregoing manner, the delay detection system 160 can accurately identify and process various complex situations in the conversation, such as a pause in questioning, a one-question-and-multiple-answers scenario, a multiple-questions-and-one-answer scenario, and a multiple-questions-and-multiple-answers scenario as described above. Regardless of that scenario, the delay detection system 160 can process the respective first audio data into the first set of audio segments 510 corresponding to the first object (e.g., the user 140) and the second audio segment set 520 corresponding to the second object (for example, the question answering system 111), thereby simplifying various complex situations into a one-question-and-one-answer scenario.

Specifically, for a “pause in questioning” scenario, the delay detection system 160 may accurately identify all audio segments belonging to the user 140 through the time gap 530 and the voiceprint recognition, so as to combine these audio segments together as the audio segment set corresponding to the user 140. In this way, even if the question of the user 140 is interrupted by a pause, the delay detection system 160 can still regard it as a complete question, thereby converting the “ pause in questioning” scenario into a “one-question-and-one-answer” scenario.

For “one-question-and-multiple-answers” scenario. The delay detection system 160 may accurately identify all audio segments belonging to the question answering system 111 through the time gap 530 and the voiceprint recognition, so as to combine these audio segments together as the audio segment set corresponding to the question answering system 111. In this way, even if the question-and-answer system 111 successively provides a plurality of answers, the delay detection system 160 may regard the plurality of answers as a complete answer, thereby converting the “one-question-and-multiple-answers” scenario into a “one-question-and-one-answer” scenario.

For a “multiple-questions-and-one-answer” scenario, the delay detection system 160 may accurately identify all audio segments belonging to the user 140 through the time gap 530 and the voiceprint recognition, so as to combine the audio segments together as the audio segment set corresponding to the user 140. In this way, even if the user 140 continuously poses a plurality of questions, the delay detection system 160 may regard the plurality of questions as a complete question, thereby converting the “multiple-questions-and-one-answer” scenario into a “one-question-and-one-answer” scenario.

For a “multiple-questions-and-multiple-answers” scenario, the delay detection system 160 may accurately identify all audio segments belonging to the user 140 through the time gap 530 and the voiceprint recognition, so as to combine the audio segments together as the audio segment set corresponding to the user 140. In addition, the delay detection system 160 may also accurately identify all audio segments belonging to the question answering system 111, so as to combine the audio segments together as the audio segment set corresponding to the question answering system 111. In this way, even if the user 140 continuously poses a plurality of questions and the question answering system 111 successively provides a plurality of answers to the plurality of questions, the delay detection system 160 may regard the plurality of questions as a complete question and regard the plurality of answers as a complete answer, thereby converting the “multiple-questions-and-multiple-answers” scenario into a “one-question-and-one-answer” scenario.

In addition, in the question-and-answer process, if the second object is eager to answer and a premature answer occurs, a question posed by the first object may be inappropriately split into two parts. In the first audio data, the two parts of questions may respectively appear before and after an answer of the second object. In some embodiments, the delay detection system 160 may divide the plurality of audio segments into the first audio segment set 510 and the second audio segment set 520 based only on the voiceprint recognition technology without using the time gap 530. In this way, the delay detection system 160 may effectively identify such a situation of question splitting caused by the premature answer, and accurately re-integrate interrupted voices of the first object into a same coherent audio segment set, and re-integrate voices of the second object into another coherent audio segment set, thereby forming a one-question-and-one-answer mode.

Once the first audio set 510 corresponding to the first object and the second audio set 520 corresponding to the second object are determined, the delay detection system 160 determines the response delay 540 between the first object and the second object based on timing information of the first audio segment set 510 in the first audio data and timing information of the second audio segment set 520 in the first audio data.

As an example, the timing information may indicate time information such as a time when the corresponding audio segment set appears in the first audio data. For example, the timing information of the first audio segment set 510 in the first audio data may indicate a start-and-end-time of the first audio segment set 510 in the first audio data. The timing information of the second audio segment set 520 in the first audio data may indicate a start-and-end-time of the second audio segment set 520 in the first audio data. The delay detection system 160 may determine a time difference between the first audio segment set 510 and the second audio segment set 520 based on start-and-end-time of the first audio segment set 510 and the start-and-end-time of the second audio segment set 520, and then determine the response delay 540 between the first object and the second object based on the time difference.

In some embodiments, in response to the first audio segment set 510 preceding the second audio segment set, the delay detection system 160 determines an end time of the first audio segment set 510 based on the timing information of the first audio segment set 510 in the first audio data. In addition, the delay detection system 160 determines a start time of the second audio segment set 520 based on the timing information of the second audio segment set 520 in the first audio data. The delay detection system 160 then determines a response delay 540 between the first object and the second object based on the time gap 530 between an end time 541 of the first audio segment set 510 and a start time 542 of the second audio segment set 520.

As an example, the delay detection system 160 determines a relative order of the first audio segment set 510 and the second audio segment set 520 in a conversation. This may be accomplished by comparing the timestamps or start times of the audio segments in the two sets. In the embodiments of the present disclosure, the first audio segment set 510 precedes the second audio segment set 520, which means that the first object provides a speech first, and then the second object provides a speech.

As an example, the end time 541 of the first audio segment set 510 may refer to an end time of a last audio segment in the set, which represents a time when the first object completes a speech. The start time 542 of the second audio segment set 520 may refer to the start time of the first audio segment in the set, which marks the moment at which the second object starts to respond.

With these two time points, the delay detection system 160 may calculate the time gap 530 between them, that is, the time difference from the end of the speech of the first object to the start of the response of the second object. This time gap 530 is the response delay between the first object and the second object. Finally, the delay detection system 160 may determine the calculated response delay 540 as an output result, which may evaluate a fluency of the conversation, a response speed, or a performance of the question answering system 111.

The foregoing describes the process of how to convert a question answering scenario into a “one-question-and-one-answer” form and to detect its response delay. However, in practical applications, there are also more complex question answering scenario, which are difficult to directly simplify into the “one-question-and-one-answer” form. For example, the question-and-answer process further includes a continuous question-and-answer scenario. The continuous question-and-answer scenario is an ongoing communication process in which whenever the user 140 poses a question, the question answering system 111 provides a corresponding answer. In this scenario, the delay detection system 160 may segment the initial audio data including the continuous question and answer to segment it into a plurality of pieces of audio data, each including one conversation (that is, one-question-and-one-answer). Then, the delay detection system 160 performs, on each segmented piece of audio data, a process such as described above to determine a response delay of each segmented piece of audio data. Then, the delay detection system 160 comprehensively determines the response delay of the initial audio data based on the response delay of each segmented piece of audio data.

In some embodiments, the delay detection system 160 divides initial audio data into at least the first audio data and second audio data based on an interaction round of the first object and the second object in the initial audio data. The first audio data corresponds to a first round of interaction between the first object and the second object in the initial audio data, and the second audio data corresponds to a second round of interaction between the first object and the second object in the initial audio data. The delay detection system 160 then obtains a first response delay between the first object and the second object determined based on the first audio data, and obtains a second response delay between the first object and the second object determined based on the second audio data. Then, the delay detection system 160 determines a response delay between the first object and the second object in the initial audio data based on at least the first response delay and the second response delay.

As an example, the initial audio data includes a plurality of rounds of interaction between the first object and the second object (for example, the continuous question-and-answer described above), and each round of interaction may include a question-and-answer process. The delay detection system 160 may identify a time period for each round of interaction from the initial audio data by, for example, voice recognition, voiceprint analysis, or a mark made in advance for each round of interaction. Then, the delay detection system 160 may determine interaction rounds based on the time period of each round of interaction, for example, a first round of interaction and a second round of interaction.

Based on the identified interaction round, the delay detection system 160 segments the initial audio data into at least the first audio data and the second audio data. The first audio data corresponds to the first round of interaction. For example, the first audio data may include a complete question-and-answer process between the first object and the second object in the first round of interaction. Correspondingly, the second audio data may correspond to the second round of interaction, the second audio data may include one complete question-and-answer process between the first object and the second object in the second round of interaction, and so on.

After the first audio data is segmented, the delay detection system 160 may determine, in the foregoing manner, the first response delay (for example, the response delay 540) between the first object and the second object in the first audio data. Similarly, the delay detection system 160 may further determine the second response delay between the first object and the second object in the second audio data by using the manner of determining the response delay 540 described above.

After obtaining the first response delay and the second response delay, the delay detection system 160 may determine a response delay between the first object and the second object in the initial audio data in combination with the response delays. For example, the delay detection system 160 may determine the response delay between the first object and the second object in the initial audio data by calculating an average value, a weighted average value, and the like of the first response delay and the second response delay.

It should be noted that, if the initial audio data includes more interaction rounds, the delay detection system 160 continues to segment the corresponding audio data. For example, the delay detection system 160 may further segment, from the initial audio data, third audio data corresponding to a third round of interaction, and the like. In addition, the delay detection system 160 may determine a response delay between the first object and the second object in the initial audio data based on an average value, a weighted average value, a median value, a mode value, or the like of the response delays in all segmented audio data.

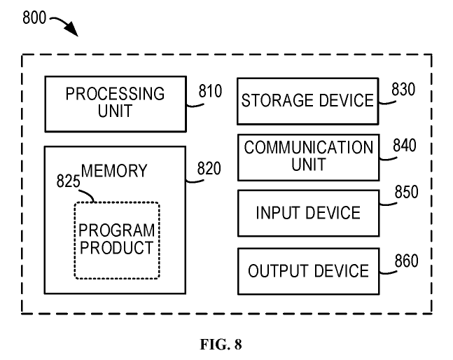

The embodiments of the present disclosure also provide a corresponding apparatus for implementing the above method or process. FIG. 7 illustrates a schematic structural block diagram of an apparatus 700 for audio data processing according to some embodiments of the present disclosure. The apparatus 700 may be implemented or included in the delay detection system 160. The various modules/components in the apparatus 700 may be implemented by hardware, software, firmware, or any combination thereof.

Referring to FIG. 7, the apparatus 700 includes an audio segment determination module 710, an audio segment division module 720, and a response delay determination module 730. The audio segment determination module 710 is configured to determine a plurality of audio segments from first audio data by performing voice activity detection on the first audio data, each audio segment being determined to include a voice. The audio segment division module 720 is configured to divide the plurality of audio segments into at least a first audio segment set and a second audio segment set based on at least a voiceprint similarity between adjacent audio segments of the plurality of audio segments, where the first audio segment set corresponds to a first object and the second audio segment set corresponds to a second object, and each audio segment set includes at least one audio segment of the plurality of audio segments. The response delay determination module 730 is configured to determine a response delay between the first object and the second object based on timing information of the first audio segment set in the first audio data and timing information of the second audio segment set in the first audio data.

In some embodiments, the second object corresponds to a question answering system, the first object provides a question voice to the question answering system, and where the response delay indicates a response delay of the question answering system.

In some embodiments, the audio segment determination module 710 is further configured to: determine, for a given frame in the first audio data, whether the given frame is a valid frame including a voice based on a time domain acoustic feature and/or a frequency domain acoustic feature of the given frame; and determine the plurality of audio segments by at least combining consecutive valid frames in the first audio data into an audio segment.

In some embodiments, the audio segment division module 720 is further configured to: perform the following operations on each audio segment in the audio segments iteratively according to a time sequence of the plurality of audio segments in the first audio data: dividing a given audio segment of the plurality of audio segments and an adjacent audio segment into a same audio segment set in response to a voiceprint similarity between the given audio segment and the adjacent audio segment exceeding a similarity threshold, and performing an iteration on a next audio segment of the plurality of audio segments in response to the voiceprint similarity between the given audio segment and the adjacent audio segment failing to exceed the similarity threshold; and determine the first audio segment set and the second audio segment set respectively based on the divided audio segment set.

In some embodiments, the audio segment division module 720 is further configured to divide the plurality of audio segments into at least the first audio segment set and the second audio segment set based on a voiceprint similarity and a time gap between adjacent audio segments in the plurality of audio segments.

In some embodiments, the audio segment division module 720 is further configured to perform the following operations on each audio segment in the audio segments iteratively according to a time sequence of the plurality of audio segments in the first audio data: dividing a given audio segment of the plurality of audio segments and an adjacent audio segment into a same audio segment set in response to a time gap between the given audio segment and the adjacent audio segment being less than a gap threshold, and determining, based on the voiceprint similarity between the given audio segment and the adjacent audio segment, whether the given audio segment and the adjacent audio segment are to be divided into a same audio segment set in response to the time gap between the given audio segment and the adjacent audio segment exceeding the gap threshold.

In some embodiments, the response delay determination module 730 is further configured to: in response to the first audio segment set preceding the second audio segment set, determine an end time of the first audio segment set based on the timing information of the first audio segment set in the first audio data, determine a start time of the second audio segment set based on the timing information of the second audio segment set in the first audio data, and determine the response delay between the first object and the second object based on a time gap between the end time of the first audio segment set and the start time of the second audio segment set.

In some embodiments, the apparatus 700 further includes an initial audio data processing module. The initial audio data processing module is configured to divide initial audio data into at least the first audio data and second audio data based on an interaction round of the first object and the second object in the initial audio data, where the first audio data corresponds to a first round of interaction between the first object and the second object in the initial audio data, and the second audio data corresponds to a second round of interaction between the first object and the second object in the initial audio data; obtain a first response delay between the first object and the second object determined based on the first audio data; obtain a second response delay between the first object and the second object determined based on the second audio data; and determine a response delay between the first object and the second object in the initial audio data based on at least the first response delay and the second response delay.

FIG. 8 illustrates a block diagram of an electronic device 800 in which one or more embodiments of the present disclosure may be implemented. For example, the electronic device 800 may be configured to implement the delay detection system 160 shown in FIG. 1 or the apparatus 700 shown in FIG. 7. It should be understood that the electronic device 800 illustrated in FIG. 8 is merely illustrative and should not constitute any limitation on the functionality and scope of the embodiments described herein.

Referring to FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor capable of performing various processes according to a program stored in the memory 820. In a multiprocessor system, a plurality of processing units executes computer-executable instructions in parallel to improve the parallel processing capabilities of electronic device 800.

The electronic device 800 typically includes a variety of computer storage media. Such media may be any available media that are accessible to the electronic device 800, including, but not limited to, volatile and non-volatile media, removable and non-removable media. The memory 820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium that can be used to store information and/or data and that can be accessed within the electronic device 800.

The electronic device 800 may further include an additional removable/non-removable, volatile/non-volatile storage medium. Although not shown in FIG. 8, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 820 may include a computer program product 828 having one or more program modules configured to execute various methods or actions of the various embodiments in the present disclosure.

The communication unit 840 is configured to communicate with other electronic devices through a communication medium. Additionally, the functionality of components of the electronic device 800 may be implemented by a single computing cluster or multiple computing machines capable of communicating through a communication connection. Thus, the electronic device 800 may operate in a networked environment using a logical connection with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed. The external device, such as a storage device, a display device, etc., communicates with one or more devices that enable users to interact with the electronic device 800, or communicates with any device (e.g., a network card, a modem, etc.) that enables the electronic device 800 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is illustrative, not exhaustive, and the present application is not limited to the disclosed implementations. Without departing from the scope and spirit of the described implementations, many modifications and changes are obvious to those skilled in the art. The terminology used herein has been determined to best explain the principles of the respective implementations, the practical applications or improvements to the technology in the marketplace, or to enable those skilled in the art to understand the implementations disclosed herein.

1. A method for audio data processing, comprising:
determining a plurality of audio segments from first audio data by performing voice activity detection on the first audio data, each audio segment being determined to comprise a voice;
dividing the plurality of audio segments into at least a first audio segment set and a second audio segment set based on at least a voiceprint similarity between adjacent audio segments of the plurality of audio segments, wherein the first audio segment set corresponds to a first object and the second audio segment set corresponds to a second object, and each audio segment set comprises at least one audio segment of the plurality of audio segments; and
determining a response delay between the first object and the second object based on timing information of the first audio segment set in the first audio data and timing information of the second audio segment set in the first audio data.

2. The method of claim 1, wherein the second object corresponds to a question answering system, the first object provides a question voice to the question answering system, and
wherein the response delay indicates a response delay of the question answering system.

3. The method of claim 1, wherein determining the plurality of audio segments comprises:
determining, for a given frame in the first audio data, whether the given frame is a valid frame comprising a voice based on a time domain acoustic feature and/or a frequency domain acoustic feature of the given frame; and
determining the plurality of audio segments by at least combining consecutive valid frames in the first audio data into an audio segment.

4. The method of claim 1, wherein dividing the plurality of audio segments into at least the first audio segment set and the second audio segment set comprises:
performing the following operations on each audio segment in the audio segments iteratively according to a time sequence of the plurality of audio segments in the first audio data:
dividing a given audio segment of the plurality of audio segments and an adjacent audio segment into a same audio segment set in response to a voiceprint similarity between the given audio segment and the adjacent audio segment exceeding a similarity threshold, and
performing an iteration on a next audio segment of the plurality of audio segments in response to the voiceprint similarity between the given audio segment and the adjacent audio segment failing to exceed the similarity threshold; and
determining the first audio segment set and the second audio segment set respectively based on the divided audio segment set.

5. The method of claim 1, wherein dividing the plurality of audio segments into at least a first audio segment set and a second audio segment set comprises:
dividing the plurality of audio segments into at least the first audio segment set and the second audio segment set based on a voiceprint similarity and a time gap between adjacent audio segments in the plurality of audio segments.

6. The method according to claim 5, wherein dividing the plurality of audio segments into at least the first audio segment set and the second audio segment set based on the voiceprint similarity and the time gap between the adjacent audio segments in the plurality of audio segments comprises:
performing the following operations on each audio segment in the audio segments iteratively according to a time sequence of the plurality of audio segments in the first audio data:
dividing a given audio segment of the plurality of audio segments and an adjacent audio segment into a same audio segment set in response to a time gap between the given audio segment and the adjacent audio segment being less than a gap threshold, and
determining, based on the voiceprint similarity between the given audio segment and the adjacent audio segment, whether the given audio segment and the adjacent audio segment are to be divided into a same audio segment set in response to the time gap between the given audio segment and the adjacent audio segment exceeding the gap threshold.

7. The method of claim 1, wherein determining the response delay between the first object and the second object comprises:
in response to the first audio segment set preceding the second audio segment set,
determining an end time of the first audio segment set based on the timing information of the first audio segment set in the first audio data,
determining a start time of the second audio segment set based on the timing information of the second audio segment set in the first audio data, and
determining the response delay between the first object and the second object based on a time gap between the end time of the first audio segment set and the start time of the second audio segment set.

8. The method of claim 1, further comprising:
dividing initial audio data into at least the first audio data and second audio data based on an interaction round of the first object and the second object in the initial audio data, wherein the first audio data corresponds to a first round of interaction between the first object and the second object in the initial audio data, and the second audio data corresponds to a second round of interaction between the first object and the second object in the initial audio data;
obtaining a first response delay between the first object and the second object determined based on the first audio data;
obtaining a second response delay between the first object and the second object determined based on the second audio data; and
determining a response delay between the first object and the second object in the initial audio data based on at least the first response delay and the second response delay.

9. An electronic device, comprising:
at least one processor; and
at least one memory coupled to the at least one processor and storing instructions for execution by the at least one processor, the instructions, when executed by the at least one processor, causing the electronic device to perform acts comprising:
determining a plurality of audio segments from first audio data by performing voice activity detection on the first audio data, each audio segment being determined to comprise a voice;
dividing the plurality of audio segments into at least a first audio segment set and a second audio segment set based on at least a voiceprint similarity between adjacent audio segments of the plurality of audio segments, wherein the first audio segment set corresponds to a first object and the second audio segment set corresponds to a second object, and each audio segment set comprises at least one audio segment of the plurality of audio segments; and
determining a response delay between the first object and the second object based on timing information of the first audio segment set in the first audio data and timing information of the second audio segment set in the first audio data.

10. The electronic device of claim 9, wherein the second object corresponds to a question answering system, the first object provides a question voice to the question answering system, and
wherein the response delay indicates a response delay of the question answering system.

11. The electronic device of claim 9, wherein determining the plurality of audio segments comprises:
determining, for a given frame in the first audio data, whether the given frame is a valid frame comprising a voice based on a time domain acoustic feature and/or a frequency domain acoustic feature of the given frame; and
determining the plurality of audio segments by at least combining consecutive valid frames in the first audio data into an audio segment.

12. The electronic device of claim 9, wherein dividing the plurality of audio segments into at least the first audio segment set and the second audio segment set comprises:
performing the following operations on each audio segment in the audio segments iteratively according to a time sequence of the plurality of audio segments in the first audio data:
dividing a given audio segment of the plurality of audio segments and an adjacent audio segment into a same audio segment set in response to a voiceprint similarity between the given audio segment and the adjacent audio segment exceeding a similarity threshold, and
performing an iteration on a next audio segment of the plurality of audio segments in response to the voiceprint similarity between the given audio segment and the adjacent audio segment failing to exceed the similarity threshold; and
determining the first audio segment set and the second audio segment set respectively based on the divided audio segment set.

13. The electronic device of claim 9, wherein dividing the plurality of audio segments into at least a first audio segment set and a second audio segment set comprises:
dividing the plurality of audio segments into at least the first audio segment set and the second audio segment set based on a voiceprint similarity and a time gap between adjacent audio segments in the plurality of audio segments.

14. The electronic device according to claim 13, wherein dividing the plurality of audio segments into at least the first audio segment set and the second audio segment set based on the voiceprint similarity and the time gap between the adjacent audio segments in the plurality of audio segments comprises:
performing the following operations on each audio segment in the audio segments iteratively according to a time sequence of the plurality of audio segments in the first audio data:
dividing a given audio segment of the plurality of audio segments and an adjacent audio segment into a same audio segment set in response to a time gap between the given audio segment and the adjacent audio segment being less than a gap threshold, and
determining, based on the voiceprint similarity between the given audio segment and the adjacent audio segment, whether the given audio segment and the adjacent audio segment are to be divided into a same audio segment set in response to the time gap between the given audio segment and the adjacent audio segment exceeding the gap threshold.

15. The electronic device of claim 9, wherein determining the response delay between the first object and the second object comprises:
in response to the first audio segment set preceding the second audio segment set,
determining an end time of the first audio segment set based on the timing information of the first audio segment set in the first audio data,
determining a start time of the second audio segment set based on the timing information of the second audio segment set in the first audio data, and
determining the response delay between the first object and the second object based on a time gap between the end time of the first audio segment set and the start time of the second audio segment set.

16. The electronic device of claim 9, wherein the acts further comprise:
dividing initial audio data into at least the first audio data and second audio data based on an interaction round of the first object and the second object in the initial audio data, wherein the first audio data corresponds to a first round of interaction between the first object and the second object in the initial audio data, and the second audio data corresponds to a second round of interaction between the first object and the second object in the initial audio data;
obtaining a first response delay between the first object and the second object determined based on the first audio data;
obtaining a second response delay between the first object and the second object determined based on the second audio data; and
determining a response delay between the first object and the second object in the initial audio data based on at least the first response delay and the second response delay.

17. A non-transitory computer-readable storage medium having a computer program stored thereon, the computer program being executable by a processor to implement acts comprising:
determining a plurality of audio segments from first audio data by performing voice activity detection on the first audio data, each audio segment being determined to comprise a voice;
dividing the plurality of audio segments into at least a first audio segment set and a second audio segment set based on at least a voiceprint similarity between adjacent audio segments of the plurality of audio segments, wherein the first audio segment set corresponds to a first object and the second audio segment set corresponds to a second object, and each audio segment set comprises at least one audio segment of the plurality of audio segments; and
determining a response delay between the first object and the second object based on timing information of the first audio segment set in the first audio data and timing information of the second audio segment set in the first audio data.

18. The non-transitory computer-readable storage medium of claim 17, wherein the second object corresponds to a question answering system, the first object provides a question voice to the question answering system, and
wherein the response delay indicates a response delay of the question answering system.

19. The non-transitory computer-readable storage medium of claim 17, wherein determining the plurality of audio segments comprises:
determining, for a given frame in the first audio data, whether the given frame is a valid frame comprising a voice based on a time domain acoustic feature and/or a frequency domain acoustic feature of the given frame; and
determining the plurality of audio segments by at least combining consecutive valid frames in the first audio data into an audio segment.

20. The non-transitory computer-readable storage medium of claim 17, wherein dividing the plurality of audio segments into at least the first audio segment set and the second audio segment set comprises:
performing the following operations on each audio segment in the audio segments iteratively according to a time sequence of the plurality of audio segments in the first audio data:
dividing a given audio segment of the plurality of audio segments and an adjacent audio segment into a same audio segment set in response to a voiceprint similarity between the given audio segment and the adjacent audio segment exceeding a similarity threshold, and
performing an iteration on a next audio segment of the plurality of audio segments in response to the voiceprint similarity between the given audio segment and the adjacent audio segment failing to exceed the similarity threshold; and
determining the first audio segment set and the second audio segment set respectively based on the divided audio segment set.
